(19) United States
(12) Patent Application Publication
(10) Pub. No.: US 2005/0067352 A1
(43) Pub. Date: Mar. 31, 2005

(54) Solar desalination or distillation apparatus

(76) Inventor: Greg Edward Kontos, Richmand, VA (US)

Correspondence Address: GREG KONTOS, 2219 W. GRACE ST. APT 5, RICHMOND, VA, 23220, US

(21) Appl. No.: 10/671,992

(22) Filed: Sep. 26, 2003

(51) Int. Cl. B01D 1/00; B01D 3/00

(52) U.S. Cl. 210/642

(57) ABSTRACT

This article of manufacture uses solar heat and heat radiated from the earth to heat and thereby evaporate salt-water along a continuous section of the article. The invention consists of a single piece of extrudable pipe which is internally separated into two chambers. The lower chamber functions as a salt-water transport and evaporation chamber. The upper chamber condenses the evaporate by means of a naturally existing temperature differential, it then collects this condensate and delivers the fresh water for irrigation or consumption depending on the placement of holes in the pipe.

### CROSS-REFERENCE TO RELATED APPLICATIONS

Provisional Patent Application No. 60/613,923 Filed Sep. 26, 2003 by Greg Kontos

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION-FIELD OF INVENTION

This invention relates to solar powered water desalination and distillation systems, specifically distributed desalination for irrigation or drinking water.

### BACKGROUND OF THE INVENTION

In large parts of the world fresh water resources are limited. Water for drinking and for irrigation therefore has to be produced from brackish water or sea water. The most common water purification methods to date have been designed for centralized use in locations along dry, ocean coasts. Inventions useful in the desalination of water have focused on complicated and expensive machinery to make water potable. Many previous inventions also rely heavily on electrical power to fuel the desalination process, further adding cost to the desalination process. In recent years the focus in desalination has been to harness solar power for use in desalination of water, thus making potable water somewhat cheaper to produce. However, these recent inventions still rely on the concept of localized factory style processing plants for salinated water drawn from the ocean. This method of water desalination causes the costs for the production of complicated machinery and shipping of fresh water to keep desalination from being a viable option for many localities around the world. This invention seeks to improve upon previous desalination devices by decreasing the cost of desalination equipment as well as de-centralizing the process of desalination, thereby making the desalination of water efficient for irrigation as well as in the creation of potable water. A number of plants and devices which employ solar energy are previously known.

DE 2503251 makes known a device for producing drinking water from polluted or saline water with the aid of solar energy. This evaporator consists of a basin with a roof in the form of an inverted V, which can be penetrated by solar energy. In the lower end of the inclined roof there is a run-off channel which receives water that has condensed on the inside of the roof.

DE 3501396 describes a similar device having a basin and a glass roof in the form of an inverted V. In the lower end of the roof there is a collecting channel for water which has condensed on the inside of the roof.

DE 2650482 describes a device consisting of a basin and a sloping glass roof, wherein the glass roof is cooled in order to enhance the condensation.

There are also a number of devices which use reverse osmosis for producing fresh water from sea water. As examples of publications which describe this, reference may be made to U.S. Pat. Nos. 4,076,626; 4,452,696; and 4,770,775.

Many factory style desalination devices also use the technique of superheating salt water solutions by using some means of producing electrical energy, be it coal, gas or nuclear power.

### BACKGROUND OF THE INVENTION-OBJECTS AND ADVANTAGES

One disadvantage of the known devices is that they are relatively bulky, expensive and stringent requirements must be met with respect to periodic maintenance. The construction of these known devices often requires trained construction crews to assemble. My device seeks to alleviate this concern by providing a method of desalination that is mass producible by using a single piece plastic extrusions.

Another disadvantage of these known devices is that they rely on a factory style paradigm for the creation of water. This has the effect of making the process of desalination centralized, and therefore fresh water created by a desalination process is created in one location. My invention seeks to make it possible to desalinate water across large expanses of territory, without the need to incur additional distribution costs.

### BRIEF SUMMARY OF THE INVENTION

This apparatus consists of a one piece article of manufacture, which is essentially a pipe partially separated into two chambers. This separation is achieved using specially shaped and oriented dividers which are internal to an outer shell, yet a part of the outer shell. The system created by the dual chamber pipe works using the principle of evaporation to produce desalinated water. Water from a salinated water source, particularly the ocean, is pumped from the source to inland areas. The water is then allowed to flow downhill through the bottom chamber of the apparatus. As the water flows down hill, the sun and radiant ground heat will cause the water to evaporate. Evaporated water that collects in the upper chamber will condense inside the chamber and flow along the sides of the pipe. Water can either be released at regular intervals for irrigation purposes or the water can be collected at designated locations along the pipe for drinking. The concentrated salt water that remains will then be returned to its source through proper placement of the pipe. It represents a departure from previous desalination devices in its lower cost of manufacture, simplicity of construction and low operational costs. It further differs from previous devices in its non-local delivery of fresh water, making the system economically feasible for irrigation.

### BRIEF DESCRIPTION OF SEVERAL VIEWS OF THE DRAWING

FIG. 1 is an elevated view illustrating a typical installation of a desalination system using this article of manufacture

FIG. 2 is a lengthwise perspective view of the article of manufacture

FIG. 3 is a cross section of the article of manufacture in FIG. 2 taken at FIG. 2 line 2

FIG. 4 is a side view of a fitting for use with the article of manufacture of FIG. 2 and FIG. 3

FIG. 5 is a cross-sectional view of the fitting of FIG. 4 taken at FIG. 5 line 1

FIG. 6 is similar to FIG. 2 and FIG. 3 but showing an alternative construction

FIG. 7 shows another alternate construction of the invention

### DRAWINGS REFERENCE NUMERALS

1. Intake Pump
2. Shore Line
3. Intake Pipe chamber
4. Salt water holding tank
5. Flow regulator valve
6. Desalinating pipe
7. Salt water return
8. Fresh water escape points
9. Salt water transport chamber
10. Fresh water collection point
11. Side wall of evaporation and condensation
12. Peak of condensation and evaporation chamber
13. Evaporation gap
14. Sectional dividers and support arms
15. Solid center portion of fitting
16. Solid upper portion of fitting

### DETAILED DESCRIPTION OF THE INVENTION

The primary intent of this article of manufacture and method of use is the desalination and delivery of fresh water at a lower cost than existing technologies.

### DETAILED DESCRIPTION-PREFERRED EMBODIMENT

The pipe in FIG. 2 is a one piece article of manufacture. The overall shape of the pipe is a tear drop shape formed by an inverted Von top and a semi-circular bottom. Inside the pipe are two intrusions 14, one on either side of the pipe which run the length of the pipe. The top of either of these two extrusions should be located at the bottom of a side 11 of the inverted V shaped top. The bottom of these intrusions should be located somewhere in the semi-circular area of the pipe. The size and angles of the pipe can be varied tremendously while still maintaining function. However the top of both intrusions must form a positive angle with the diameter of the semi-circle. The gap 13 between these two intrusions may also be varied tremendously, but should not be smaller than half the width of the pipe. A larger gap will provide for increased air flow, and therefore greater evaporative power. The width of the material used in the manufacture of the pipe can vary according to the material used and the overall dimensions of the pipe. I found that a stable product required a 0.093″ wall width. I have found that it is best and cheapest to use a white colored material in the manufacture of the pipe, although many colors would work equally well.

I have found that the cheapest and most expedient way to produce this pipe is by using custom profile PVC extrusion. While the pipe could theoretically be produced to any overall physical dimensions available manufacturing facilities which are able to make custom profile extrusions are limited by the overall diameter of the product. Other materials can also be used in the manufacture of the pipe, such as but not limited to other plastic compounds, fiberglass, metals, etc. This is because the water within the pipe will not reach temperatures above boiling. When salt water reaches temperatures around the boiling point it becomes highly corrosive.

Holes 8 should be drilled into the pipe at regular intervals to allow fresh water to escape.

### DETAILED DESCRIPTION-OPERATION

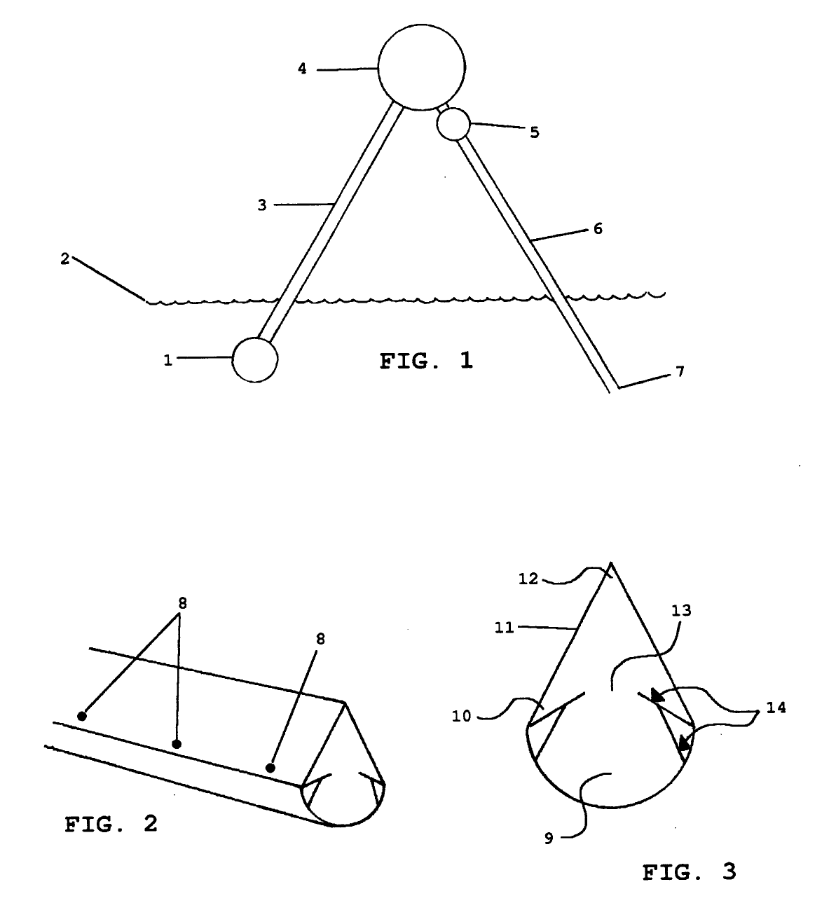

The article of manufacture claimed is intended for use in a desalination system such as that shown as example in FIG 1. It may, however, be used in other applications for use in purification of liquids. In the example shown in FIG. 1 water is pumped from a body of sea water from a point below shore line 2, representing the low water mark or the yearly low tide of ocean shores. Water is pumped from pump 1 through pipe 3. The water is then held in reservoir tank 4. Water is released from tank 4 through at a volume regulated by valve 5. The water then flows into pipe 6, which is shown in greater detail in FIG. 2 and FIG. 3. Pipe 6 provides a means of evaporating a flow of salt water, collecting the evaporate, allowing the evaporate to condense, collecting the condensate and releasing the condensed fresh water for either irrigation along the pipe, or collecting the water for drinking. After evaporation along the length of pipe 6, the resulting highly saline water is released from the system to return to its source.

Water is pumped from 1 using the most conveniently available or economically sound pumping mechanism available and feasible in the environment surrounding the installation. The total distance and elevation of reservoir tank 4 from low tide line 2 should be taken into consideration when choosing a pump for the system, as the water flow must reach tank 4. The author recommends a wave generated pump such as that described in U.S. Pat. No. 4,954,052 when ever sufficient flow can be generated from such a pump.

Intake pipe 3 should be a standard pipe capable of carrying salt water without the introduction of chemicals or minerals hazardous to drinking water, such as lead. The author recommends fiber glass or polyvinyl chloride (PVC) pipe. The length of the individual sections of pipe should be determined by availability and local standards. Fittings for the pipe should also be standard and attached in standard fashion for water flow systems. The gauge of pipe 3 should be determined by the capacity of the lower chamber 9 of pipe 6. The lower chamber 9 should not be completely filled as this increases the chances of saltwater contaminating the fresh water collected at FIG. 3 line 2.

The reservoir tank 4 is included for means of ensuring a continuous and even flow through pipe 6. Reservoir tank 4 should be made of a material suitable for holding saltwater without the introduction of chemicals and minerals which may be hazardous for drinking or irrigation. The water level in tank 4 should be of sufficient height to ensure that water will flow continuously down-hill to the source of the water. Reservoir tank 4 should not need to be very large because the rate of flow of out take pipe 6 and intake pump 1 can be matched to avoid waste. It is not desirable to overfill tank 4, as this will cause a back up of water in pipe 3 and a waste of energy at pump 1.

The flow control of valve 5 can be as simple as a hand operated valve attached to the tank open to allow an amount of water ½ to ¾ the capacity of the bottom chamber 9 to flow from tank 4. Valve 5 could also be closed at night using light sensitive or time controlled switches and electronically controlled valves. This would allow water to accumulate in reservoir tank 4 at night and permit a greater amount of flow through a larger out take pipe 6 during the day, thus increasing the output of the system. The size of reservoir tank 4 must be varied accordingly to ensure water flow continues through the pipe to outlet 7 as described above. The illustration in FIG. 1 can also be modified to include several out take pipes similar to 6 working from a single pump 1, thus allowing the system to cover more area. It should be noted, however, that water flowing through pipe 6 particularly early in the evening will still evaporate due to radiant ground heat.

Once water is released into pipe 6, salt-water will flow through the pipe along the bottom chamber 9, being heated by the sun and radiant ground heat as it travels. The length and diameter of pipe 6 should be determined by the surrounding environmental variables. Water in the bottom chamber 9 must be of sufficient volume to allow return to its source at out take 7 without the salt and mineral contents of the water precipitating out of the aqueous solution. Precipitated salts and minerals can build up in the pipe and cause a backup of the system resulting in an overflow of bottom chamber 9 and causing contamination of the fresh water accumulated at 2. A larger diameter pipe will also allow for a greater rate of evaporation as the surface area of the salt water flowing through chamber 9 will be increased. The solar heating and radiant heat from the earth will cause the water to evaporate and the resulting evaporate to escape from 9 through the opening 13 located at the top of the pipe. The evaporate will then condense on the inner surface 11 of the pipe. The condensate will then flow from peak 12 down the sides of the pipe 11 where it will pool at the collection point 10 which is created by the sectional dividers 14. The resulting desalinated water can then be released for irrigation by means of small openings 8 in the outer surface of the pipe. The resulting desalinated water can also be collected at less regular intervals and collected into reservoir tanks for consumption. The high-salt concentration water should then be returned to the source of the saltwater by means of laying the path of the pipe so that the last section of the pipe empties into the body of water being used as the source.

The opening 5 should be approximately ⅔ the diameter of the pipe. The larger the opening is the more evaporate will be allowed to escape the bottom chamber 9. However, the larger the opening is, the greater the chance that salt water will escape section 9 by means of overflow, thus contaminating the system. The pipe 6 should be installed as close to the ground as possible while maintaining a decline in the pipe. This is to take advantage of the radiant heat from the earth as well as the sun in the evaporation process.

The greater the overall height of the pipe, particularly the distance between the bottom section 9 and the peak 12, the greater the temperature differential will be between the salt water flowing through pipe the bottom chamber 9 the air at the peak 12. As this temperature differential increases the rate of condensation will also increase. This will increase the efficiency of the system not only by increasing the amount of fresh water created by the system, but also by decreasing the relative humidity of the system inside the pipe. Decreasing the relative humidity will increase the rate of evaporation of the system which will increase the efficiency of the system further.

The length of individual sections of pipe 6 should be determined by the manufacturing facilities available as well as the available means of transportation. The smaller or larger lengths of individual sections of pipe will not affect the performance of pipe 6 or the system.

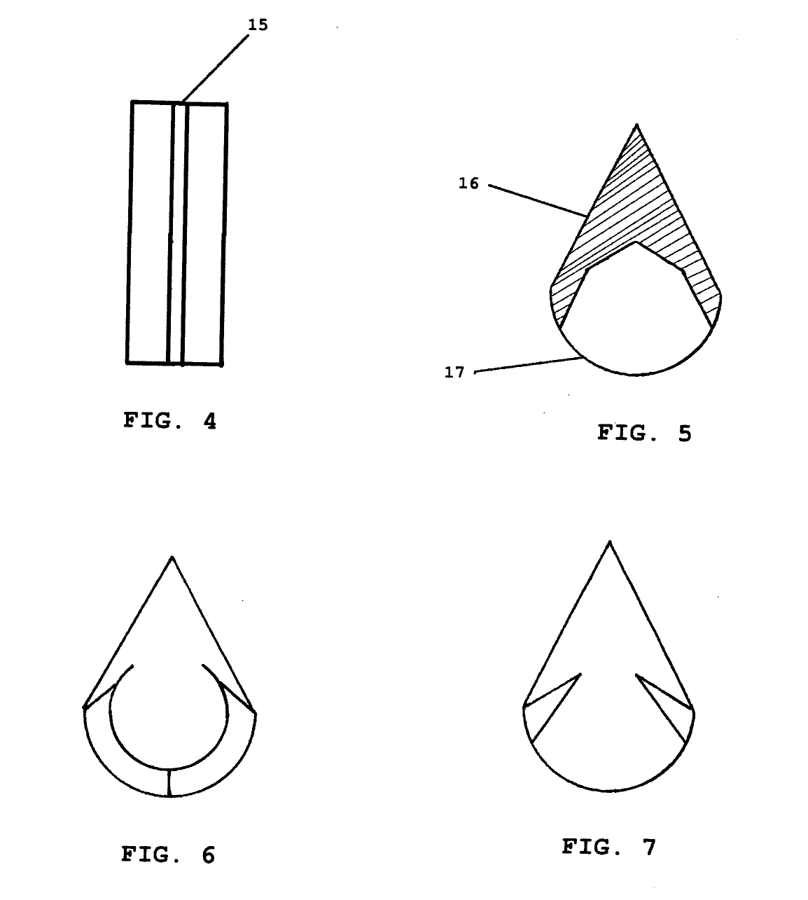

The sections of pipe should be joined using fittings shown in FIG. 4 and FIG. 5. The fittings contain a thin solid piece 15 along the middle of the fitting that matches the dimensions of the upper chamber FIG. 3. This solid piece will allow water to flow through the bottom chamber 9 while protecting the system against accidental contamination. The use of these specialized fittings can make the system contiguous for any desired distance.

The pipe in FIG. 2 and FIG. 3 can be manufactured from any material that is suitable to carry water for human consumption. Material should also be chosen that will be able to stand the heat which will be produced by solar radiation, as well as radiant ground heat. The recommended material in terms of cost and relative endurance is Polyvinyl Chloride (PVC) or fiberglass. PVC will allow for cost effective construction by means of plastic extrusion through a form similar to FIG. 2. Lengths of individual sections of pipe can vary according to the methods of manufacture available for each material. The article in FIG. 2 and FIG. 3 can be in a single piece construction such as that consistent with extruding plastics.

Out take 7 should be placed as far from intake pump 2 as economically possible to ensure that the lowest salinity water possible is used in the system.

1) I claim a partially separated dual chambered pipe for the desalination or distillation of water comprising
1. A single piece manufacture
2. An outer shell, semi-circular on the bottom and triangular at the top;
3. A lower chamber for the transport of salt or brackish water and the evaporation of said water;
4. An upper chamber for the condensation of evaporate and collection and distribution of the evaporate,
5. Two separators with supports declining towards the outside of the article of manufacture and split in the center of the pipe;
6. The above parts created by their manufacture form a self-contained system for the desalination or distillation of water.

2) I claim the fitting shown in FIGS. 4 and 5 which will connect sections of said pipe claimed in 1.

3) I claim the method of water desalination which includes
1. Pumping salt or brackish water inland
2. Allowing aforementioned water to flow back towards the ocean under the power of gravity through the pipe in claim 1 or a similar apparatus in order to produce fresh water
